(19) United States
(12) Patent Application Publication
(10) Pub. No.: US 2014/0361031 A1
(43) Pub. Date: Dec. 11, 2014

(54) METHODS AND APPARATUS FOR DISPENSING SOLID PHARMACEUTICAL ARTICLES USING CAPACITIVE LEVEL SENSORS

(71) Applicant: Parata Systems, LLC, Durham, NC (US)

(72) Inventors: Eric X. Bonpain, Cary, NC (US); Gary M. Owen, Wake Forest, NC (US); Kevin M. Park, Cary, NC (US)

(21) Appl. No.: 14/302,034

(22) Filed: Jun. 11, 2014

Related U.S. Application Data
(60) Provisional application No. 61/833,486, filed on Jun. 11, 2013.
(60) Provisional application No. 61/924,493, filed on Jan. 7, 2014.

(51) Int. Cl. A61J 7/00

(52) U.S. Cl. CPC A61J 7/0084
USPC 221/1; 221/7

(57) ABSTRACT

An apparatus for dispensing solid pharmaceutical articles includes a dispensing bin having a solid pharmaceutical article storage chamber therein, and a sensor system. The sensor system includes a sensor having first and second electrodes in the storage chamber, and a controller coupled to the sensor. The sensor is configured to generate a detection signal indicative of a capacitance. The controller is configured to detect a presence of one or more solid pharmaceutical articles in the storage chamber based on the capacitance indicated by the detection signal. Related methods and computer program products are also discussed.

### CLAIM OF PRIORITY

This application claims priority from U.S. Provisional Patent Application Nos. 61/833,486, filed Jun. 11, 2013, and 61/924,493, filed Jan. 7, 2014, both of which are entitled “Methods and Apparatus for Dispensing Solid Pharmaceutical Articles Using Capacitive Level Sensors,” the disclosures of which are incorporated by reference herein in their entireties.

### FIELD

The present invention is directed generally to the dispensing of solid articles and, more specifically, is directed to the automated dispensing of solid articles, such as solid pharmaceutical articles.

### BACKGROUND

Pharmacy generally began with the compounding of medicines which entailed the actual mixing and preparing of medications. Heretofore, pharmacy has been, to a great extent, a profession of dispensing, that is, the pouring, counting, and labeling of a prescription, and subsequently transferring the dispensed medication to the patient. Because of the repetitiveness of many of the pharmacist's tasks, automation of these tasks has been desirable.

Some attempts have been made to automate the pharmacy environment. For example, U.S. Pat. No. 6,971,541 to Williams et al. describes an automated system for dispensing pharmaceuticals using dispensing bins. Each dispensing bin includes a hopper in which tablets are stored and a dispensing channel fluidly connecting the hopper to a dispensing outlet. Forward and reverse air flows are used to selectively convey the tablets through the dispensing channel in each of a dispensing direction (toward the outlet) and a reverse direction (toward the hopper). A counting sensor may be positioned proximate the outlet of the dispensing channel and used to detect tablets passing the sensor in order to maintain a count of the tablets dispensed.

### SUMMARY

According to embodiments of the present invention, a method for detecting solid articles using an apparatus including a non-optical type sensor system is provided, which may unaffected by dust buildup or ambient light. In particular, embodiments of the present invention can detect the level of pills inside a dispensing bin (or “cell”) in a pharmacy automation system by using a variable capacitor to sense the presence and/or level of the pills.

According to some embodiments, an apparatus for dispensing and detecting solid articles includes a housing defining a dispensing channel through which articles can travel along a dispensing pathway and a storage chamber adjacent thereto, and a sensor system. The sensor system includes first and second electrodes, and is configured to generate a detection signal indicative of a dielectric property or capacitance between the first and second electrodes. A controller coupled to the sensor is configured to determine a presence of one or more of the solid articles based on the dielectric property or capacitance indicated by the detection signal.

According to some embodiments, a method for dispensing solid pharmaceutical articles uses an apparatus including a housing and a sensor system. The housing defines a hopper chamber and a dispensing channel adjacent thereto, the dispensing channel having a dispensing inlet and a dispensing outlet downstream of the dispensing inlet. The sensor system includes at least one sensor in the chamber adjacent the dispensing channel. A detection signal indicative of a change in capacitance or dielectric property is generated by the at least one sensor. The change in capacitance or dielectric property indicated by the detection signal from the sensor is interpreted to identify a presence and/or amount of solid pharmaceutical articles in the chamber.

According to some embodiments, an apparatus for dispensing solid pharmaceutical articles includes a dispensing bin having a solid pharmaceutical article storage chamber therein, and a sensor system. The sensor system includes a sensor having first and second electrodes defining a plurality of interlocking fingers having respective gaps therebetween in the storage chamber, and a controller coupled to the sensor. The sensor is configured to generate a detection signal. The controller is configured to detect a presence of one or more solid pharmaceutical articles in the storage chamber based on the capacitance indicated by the detection signal.

In some embodiments, a capacitance indicated by the detection signal may vary based on the presence of the one or more of the solid pharmaceutical articles between the fingers of the first and second electrodes.

In some embodiments, the controller may be further configured to determine a fill level of the solid pharmaceutical articles in the storage chamber based on the capacitance indicated by the detection signal and a physical orientation of the sensor in the storage chamber.

In some embodiments, the controller may be configured to determine a dielectric constant between the fingers of the first and second electrodes based on the capacitance indicated by the detection signal. The sensor may be physically oriented in the storage chamber such that the dielectric constant may increase with quantity of the solid pharmaceutical articles.

In some embodiments, the interlocking fingers of the sensor may extend in a direction along a height of the storage chamber. In such a physical orientation, generation of the detection signal may be substantially unaffected by dust in the storage chamber.

In some embodiments, the sensor may include a plurality of interdigital capacitors having respective pairs of the first and second electrodes and configured to generate respective detection signals. The controller may be configured to determine the fill level based on a comparison of respective dielectric constants between the fingers of the respective pairs of the first and second electrodes indicated by the respective detection signals and the physical orientation of the sensor.

In some embodiments, the physical orientation of the sensor may define a columnar arrangement of the interdigital capacitors along a height of the storage chamber. The controller may be configured to determine the fill level based on respective positions of the interdigital capacitors in the columnar arrangement.

In some embodiments, the interdigital capacitors may be coupled to respective independent sensor circuits, which may be configured to output the respective detection signals. The respective dielectric constants may be indicated by relative operating frequencies of the respective sensor circuits.

In some embodiments, the respective detection signals output by the independent sensor circuits may include information, such as addressing information, indicating the respective positions of the interdigital capacitors in the columnar arrangement.

In some embodiments, the controller may be configured to determine that the fill level is below a predetermined threshold based on the respective detection signals and the respective positions of the interdigital capacitors in the columnar arrangement, and may be configured to generate an alert signal responsive thereto.

According to some embodiments, in a method for dispensing solid pharmaceutical articles, a detection signal may be generated by a sensor having first and second electrodes defining a plurality of interlocking fingers having respective gaps therebetween in a solid pharmaceutical article storage chamber. A presence of one or more solid pharmaceutical articles in the storage chamber may be detected by a controller coupled to the sensor, based on the detection signal.

In some embodiments, a fill level of the solid pharmaceutical articles in the storage chamber may be determined based on the capacitance indicated by the detection signal and a physical orientation of the sensor in the storage chamber.

In some embodiments, a dielectric constant between the fingers of the first and second electrodes may be determined based on the capacitance indicated by the detection signal. Based on the physical orientation of the sensor in the storage chamber, the dielectric constant may increase with quantity of the solid pharmaceutical articles.

In some embodiments, the sensor may include a plurality of interdigital capacitors having respective pairs of the first and second electrodes. Respective detection signals may be generated by the interdigital capacitors, and the fill level may be determined by the controller based on a comparison of respective dielectric constants between the fingers of the respective pairs of the first and second electrodes indicated by the respective detection signals and the physical orientation of the sensor.

In some embodiments, the physical orientation of the sensor may define a columnar arrangement of the interdigital capacitors along a height of the storage chamber. The fill level may be determined based on respective positions of the interdigital capacitors in the columnar arrangement.

In some embodiments, the fill level may be determined to be below a predetermined threshold based on the respective detection signals and the respective positions of the interdigital capacitors in the columnar arrangement, and an alert signal may be generated responsive to the determination.

According to some embodiments, a computer program product for dispensing and detecting solid pharmaceutical articles includes a computer readable storage medium having computer readable program code embodied in the medium. The computer readable program code, when executed by a processor, causes the processor to receive a detection signal from a sensor in a solid pharmaceutical article storage chamber. The sensor includes first and second electrodes defining a plurality of interlocking fingers having respective gaps therebetween. The computer readable program code, when executed by the processor, further causes the processor to detect a presence and/or fill level of solid pharmaceutical articles in the storage chamber based on the detection signal.

Other methods, devices, and/or computer program products according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a front perspective view of a pharmaceutical tablet dispensing system according to some embodiments of the present invention.

FIG. 2 is a cutaway, rear perspective view of the tablet dispensing system of FIG. 1 illustrating a container dispensing station, a labeling carrier, a dispensing carrier, and a closure dispensing station thereof.

FIG. 3 is a top, front perspective view of a dispensing bin according to some embodiments of the present invention and forming a part of the tablet dispensing system of FIG. 1.

FIG. 4 is a cross-sectional, perspective view of the bin of FIG. 3 taken along the line 4-4 of FIG. 3.

FIG. 5 is a cross-sectional view of the bin of FIG. 3 wherein tablets contained therein are at rest.

FIG. 6 is a cross-sectional view of the bin of FIG. 3 wherein tablets contained therein are being agitated and dispensed.

FIG. 7 is a cross-sectional view of the bin of FIG. 3 wherein tablets contained therein are being agitated and returned to a hopper chamber of the bin.

FIGS. 8A-8B are diagrams illustrating a sensor system according to some embodiments of the present invention.

FIGS. 9A-9B are diagrams illustrating operation of the sensor system of FIG. 8A.

FIGS. 10A-10D illustrate example implementations of a sensor system according to some embodiments of the present invention.

FIGS. 11A-11H illustrate example implementations of a sensor system according to some embodiments of the present invention in a bin as shown in FIG. 3.

FIG. 12 illustrates an example implementation of a sensor system according to further embodiments of the present invention in a bin as shown in FIG. 3.

FIG. 13 is a flowchart illustrating operation of a sensor system according to some embodiments of the present invention.

### DETAILED DESCRIPTION OF EMBODIMENTS

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In accordance with embodiments of the present invention, apparatus and methods are provided for dispensing solid articles. According to some embodiments, the solid articles are solid pharmaceutical articles. In particular, such methods and apparatus may be used to dispense pharmaceutical pills or tablets.

Embodiments of the present invention may arise from realization that, in automated pharmaceutical dispensing systems, user filling error can result in pill quantity discrepancies, which may reduce the efficiency of a machine (for example, by creating exceptions), reduce system accuracy, and/or require unanticipated downtime and additional human input.

According to embodiments of the present invention, an apparatus for dispensing and detecting solid articles, such as pharmaceutical articles, includes a housing that defines a dispensing channel. A sensor, such as a dielectric or capacitive sensor, is positioned in the apparatus adjacent the dispensing channel (for example, in the hopper chamber). The dielectric sensor is configured to measure changes in dielectric properties between electrodes of the sensor and generate signals according to the measured dielectric properties, which may indicate the presence, absence, and/or quantity/amount of solid articles positioned between the electrodes of the sensor.

Apparatus as described according to embodiments of the present invention can provide more consistent and reliable detection of articles in bins and/or passing through the dispensing channel. More particularly, the changes in dielectric constant measured by the sensor may indicate the presence and/or fill level of pills in the bin and/or dispensing channel. Sensors according to some embodiments of the present invention may be calibrated to have limited sensitivity to dust, which is typically present in a dispensing bin due to fragments/portions of pills that may accumulate therein. The sensor may include a sensing area having a location and/or geometry relative to the geometry of the dispensing bin that serves to reduce or minimize inaccurate measurements, for example, due to dust accumulation and/or sensing blind spots. As used herein, a sensing blind spot refers to a position or region of the dispensing bin or channel in which pharmaceutical articles (or fragments thereof) may rest or pass through without detection by the sensor.

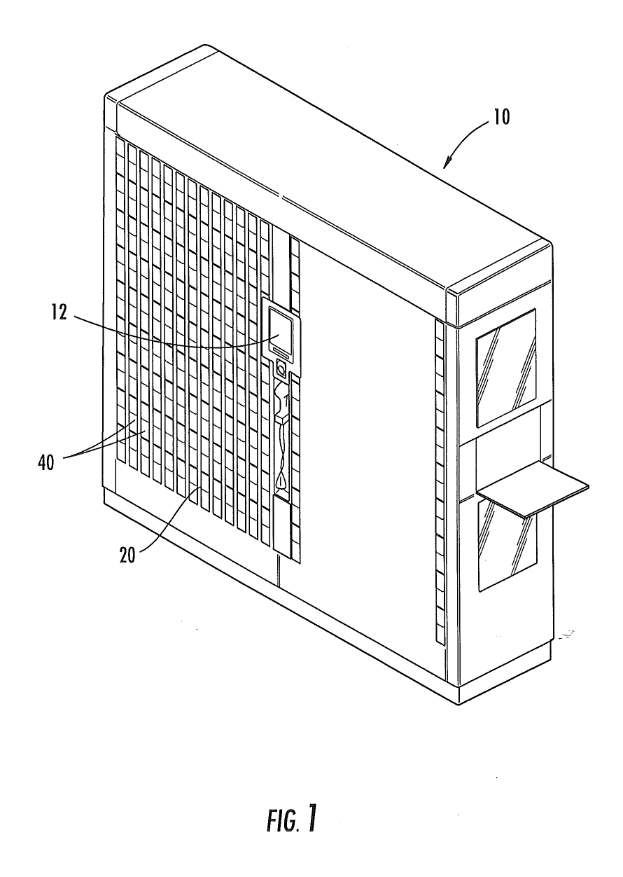

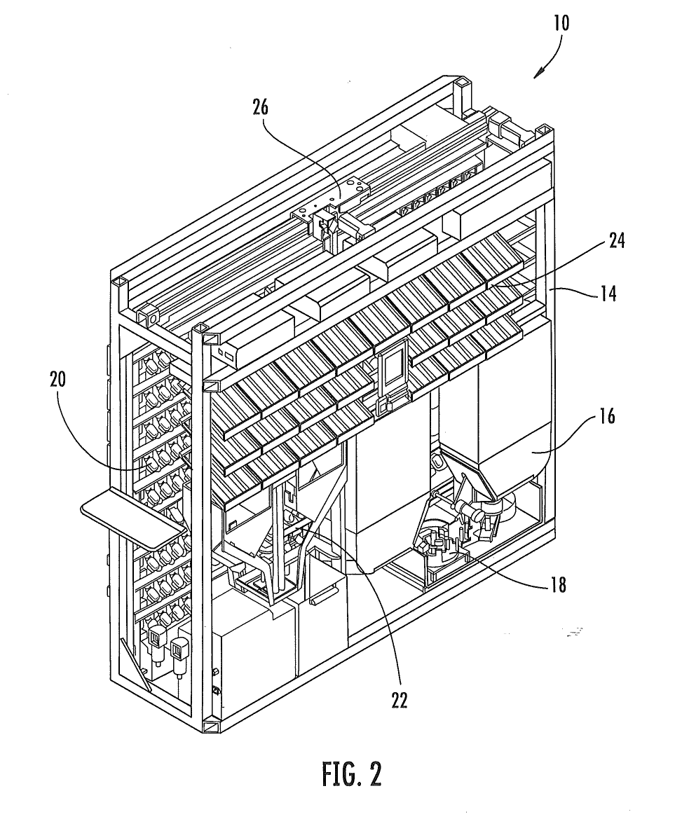

A dispensing system according to embodiments of the present invention is illustrated in FIGS. 1-11 and designated broadly therein at 10 (FIGS. 1 and 2). The dispensing system 10 includes a support frame 14 for the mounting of its various components. Those skilled in this art will recognize that the frame 14 illustrated herein is exemplary and can take many configurations that would be suitable for use with the present invention. The frame 14 provides a strong, rigid foundation to which other components can be attached at desired locations, and other frame forms able to serve this purpose may also be acceptable for use with this invention.

The system 10 generally includes as operative stations a controller (represented herein by a graphical user interface 12), a container dispensing station 16, a labeling station 18, a tablet dispensing station 20, a closure station 22, and an offloading station 24. In the illustrated embodiment, containers, tablets and closures are moved between these stations with a dispensing carrier 26; however, in some embodiments, multiple carriers are employed. The dispensing carrier 26 has the capability of moving the container to designated locations within the frame 14. Except as discussed herein with regard to the dispensing station 20, each of the operative stations and the conveying devices may be of any suitable construction such as those described in detail in U.S. Pat. Nos. 6,971,541, 7,344,049, 8,261,936, 7,596,932, and 7,344,049, and U.S. patent application Publication Ser. No. 11/599,576, the disclosures of which are hereby incorporated herein in their entireties.

The controller 12 controls the operation of the remainder of the system 10. In some embodiments, the controller 12 will be operatively connected with an external device, such as a personal or mainframe computer, that provides input information regarding prescriptions. In other embodiments, the controller 12 may be a stand-alone computer that directly receives manual input from a pharmacist or other operator. The controller 12 may be distributed with a portion thereof mounted on each bin as described below. As used herein, the controller 12 may refer to a central controller and/or a dedicated controller onboard an associated bin. An exemplary controller is a conventional microprocessor-based personal computer. The controller 12 may be implemented by entirely hardware, entirely software (including firmware, resident software, micro-code, etc.) or a combination of software and hardware, all of which may generally be referred to herein as a “circuit,” “module,” “component,” or “system.” Furthermore, aspects of the present disclosure may take the form of a computer program product embodied in one or more computer readable media having computer readable program code embodied thereon that, when executed by the controller 12, causes the controller to perform the operations described herein.

In operation, the controller 12 signals the container dispensing station 16 that a container of a specified size is desired. In response, the container dispensing station 16 delivers a container to the labeling station 18. The labeling station 18 includes a printer that is controlled by the controller 12. The printer prints and presents an adhesive label that is affixed to the container. The carrier 26 moves the labeled container to the appropriate bin 40 for dispensing of tablets in the container.

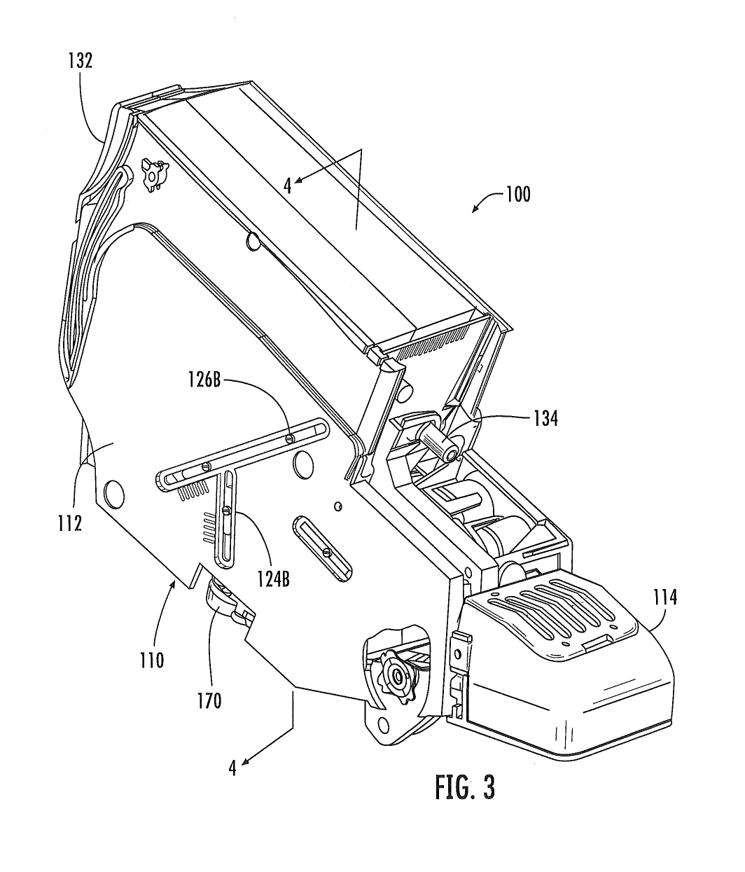

Filling of labeled containers with tablets is carried out by the tablet dispensing station 20. The tablet dispensing station 20 comprises a plurality of tablet dispensing bin assemblies or bins 100 (described in more detail below), each of which holds a bulk supply of individual tablets (typically the bins 100 will hold different tablets). The dispensing bins 100, which may be substantially identical in size and configuration, are organized in an array mounted on the rails of the frame 14. Each dispensing bin 100 has a dispensing passage or channel 116 that communicates with a portal or outlet 114A (FIG. 4) that faces generally in the same direction to create an access region for the dispensing carrier 26. The identity of the tablets in each bin 100 is known by the controller 12, which can direct the dispensing carrier 26 to transport the container to the proper bin 100. In some embodiments, the bins 100 may be labeled with a bar code, RFID tag or other indicia to allow the dispensing carrier 26 to confirm that it has arrived at the proper bin 100.

The dispensing bins 100 are configured to singulate, count, and dispense the tablets contained therein, with the operation of the bins 100 and the counting of the tablets being controlled by the controller 12. Some embodiments may employ the controller 12 as the device which monitors the locations and contents of the bins 100; others may employ the controller 12 to monitor the locations of the bins, with the bins 100 including indicia (such as a bar code or electronic transmitter) to identify the contents to the controller 12. In still other embodiments, the bins 100 may generate and provide location and content information to the controller 12, with the result that the bins 100 may be moved to different positions on the frame 14 without the need for manual modification of the controller 12 (i.e., the bins 100 will update the controller 12 automatically).

After the container is desirably filled by the tablet dispensing station 20, the dispensing carrier 26 moves the filled container to the closure dispensing station 22. The closure dispensing station 22 may house a bulk supply of closures and dispense and secure them onto a filled container. The dispensing carrier 26 then moves to the closed container, grasps it, and moves it to the offloading station 24.

Turning to the bins 100 in greater detail, an exemplary bin 100 is shown in more detail in FIGS. 3-7. The bin 100 includes a housing 110 having a hopper portion 112 and a nozzle 114. The bin 100 is fluidly connected with a pressurized gas source 136 as discussed in more detail below.

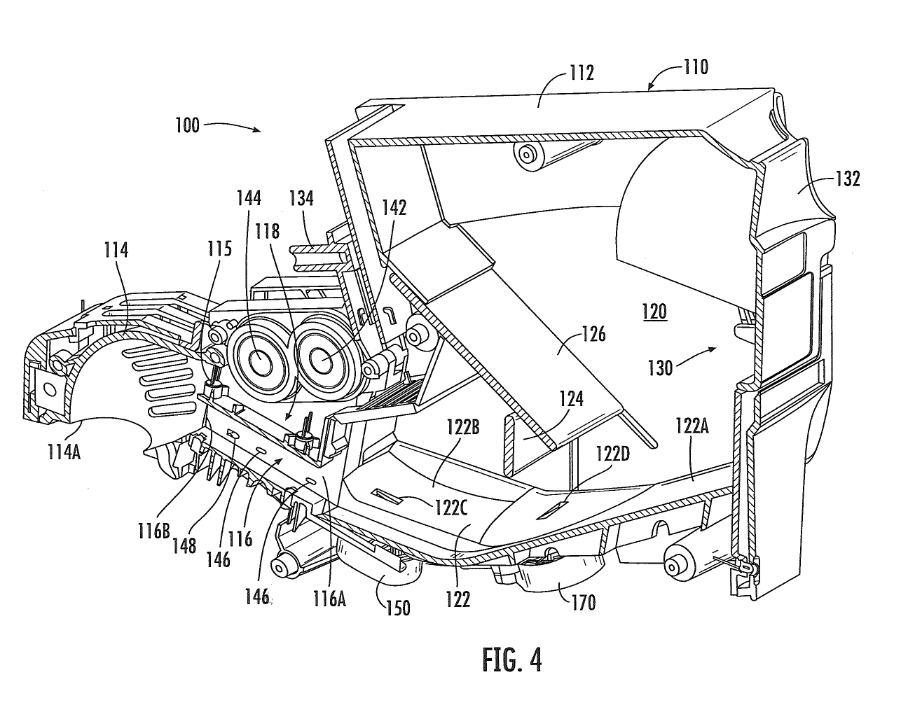

Referring to FIGS. 4 and 5, the hopper portion 112 defines a hopper chamber (or storage chamber) 120 that can be filled with pills or tablets T (FIG. 5). The bin 100 can be filled or replenished with tablets through an opening 130 located at the upper rear portion of the bin 100. The opening 130 is selectively accessible via a pivoting door 132, for example.

The bin 100 further includes an adjustable dispensing channel subassembly 118, only a portion of which is shown in the drawings. The adjustable dispensing channel subassembly 118 may be configured as disclosed in co-assigned U.S. Pat. No. 7,949,427, filed Mar. 20, 2008, the disclosure of which is incorporated herein by reference. According to some embodiments, the heightwise and widthwise dimensions of the dispensing channel 116, the inlet 116A, and the outlet 116B can be selectively configured using the adjustment mechanisms of the adjustable dispensing channel subassembly 118.

With reference to FIG. 4, the hopper portion 112 has a bottom wall defining a floor 122. The floor 122 has a sloped rear portion 122A that slopes downwardly toward the inlet 116A. The floor 122 also has a funnel-shaped front portion 122B. A front agitation port or outlet 122C and a rear agitation port or outlet 122D are provided in the floor 122. As discussed below, air or other pressurized gas can be flowed through the outlets 122C, 122D and into the chamber 120 to agitate the tablets T contained therein.

With reference to FIG. 5, a front partition or divider wall 124 extends through the hopper chamber 120 and forms a gap or choke point 124A (FIG. 3) between the lower edge of the wall 124 and the floor 122. According to some embodiments, the choke point 124A has a gap spacing or height of between about 0.25 and 0.75 inch. The position of the wall 124, and thereby the gap spacing, may be selectively adjusted using an adjustment mechanism 124B (FIG. 3).

A rear partition or divider wall 126 extends through the hopper chamber 120 and forms a gap or choke point 126A between the lower edge of the wall 126 and the floor 122. According to some embodiments, the choke point 126A has a gap spacing or height of between about 0.6 and 1 inch. The position of the wall 126, and thereby the gap spacing, may be selectively adjusted using an adjustment mechanism 126B (FIG. 3). According to some embodiments, the rear divider wall 126 forms an angle A (FIG. 5) of at least about 30 degrees with respect to horizontal and, according to some embodiments, between about 30 and 45 degrees with respect to horizontal.

The front divider wall 124 and rear divider wall 126 divide the hopper chamber 120 into subchambers or regions. More particularly and referring to FIG. 5, a front region or subchamber 120A is defined between the divider wall 124 and the inlet 116A, an intermediate region or subchamber 120B is defined between the front divider wall 124 and the rear divider wall 126, and a rear region or subchamber 120C is defined between the rear divider wall 126 and the rear wall of the bin 100.

With reference to FIG. 5, the housing 110 further includes a high pressure supply port or nozzle 134. In use, the pressurized gas source 136 is fluidly connected to the high pressure nozzle 134 via a manifold, fitting, flexible or rigid conduit 136A, or the like. The gas source 136 may include a compressor or a container of compressed gas, for example. The high pressure gas source 136 is operative to provide a supply gas flow of a suitable working gas at a high pressure to the nozzle 134. According to some embodiments, the supplied gas is or includes air. According to some embodiments, the pressure of the supplied gas at the nozzle 134 is at least about 10 psi and, according to some embodiments, between about 10 and 60 psi. However, while illustrated herein with reference to use in a positive pressure system, it will be understood that embodiments of the present invention (including the bins 100 described above and/or the sensor systems 500 described below) may also be used in a vacuum system, as described for example in U.S. Pat. No. 8,499,967, filed Jun. 26, 2009, entitled Methods and Apparatus for Dispensing Solid Articles, the disclosure of which is incorporated by reference herein its entirety.

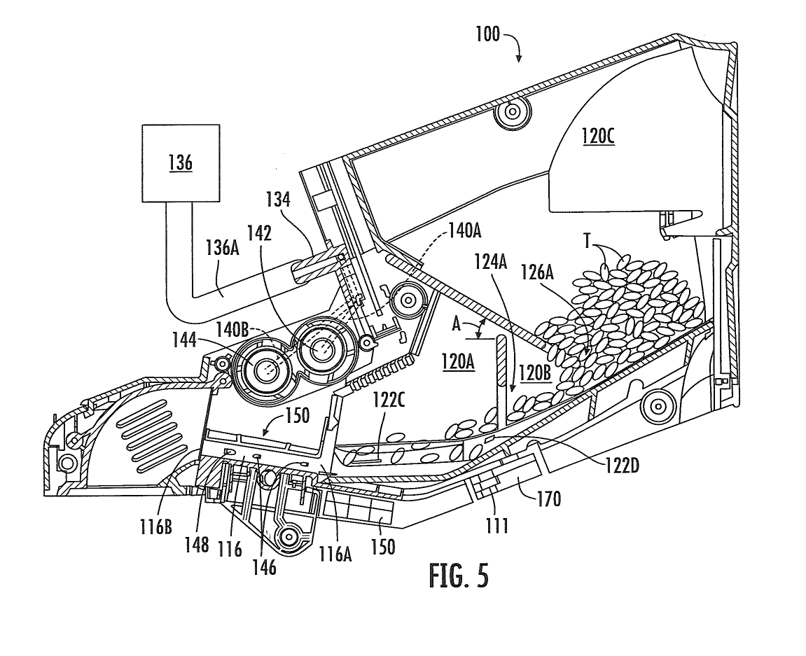

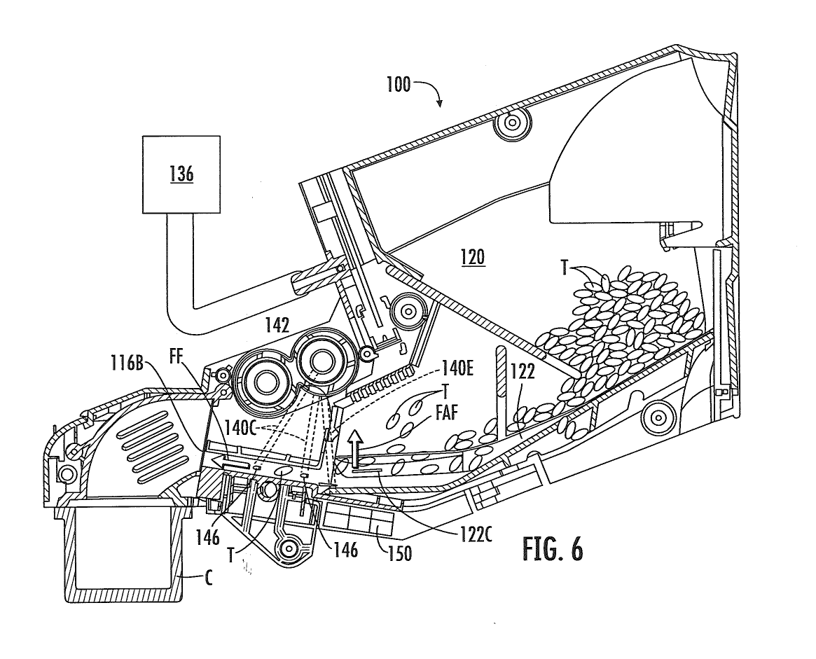

With reference to FIGS. 5 and 6, a gas supply passage or conduit 140A (FIG. 5) fluidly connects the high pressure nozzle 134 to a forward control valve 142. Two forward jet supply passages 140C (FIG. 6) fluidly connect the forward control valve 142 to respective forward drive jet apertures or outlets 146. The forward jet outlets 146 are positioned and configured to direct air or other supplied gas into the dispensing channel 116. A front agitation supply passage 140E (FIG. 6) fluidly connects the forward control valve 142 to a front agitation jet device 150. The front agitation jet device 150 is positioned and configured to direct air or other supplied gas into the hopper chamber 120 through the front agitation outlet 122C. The forward control valve 142 is operable to control airflow to the forward jet outlets 146 and the front agitation jet device 150.

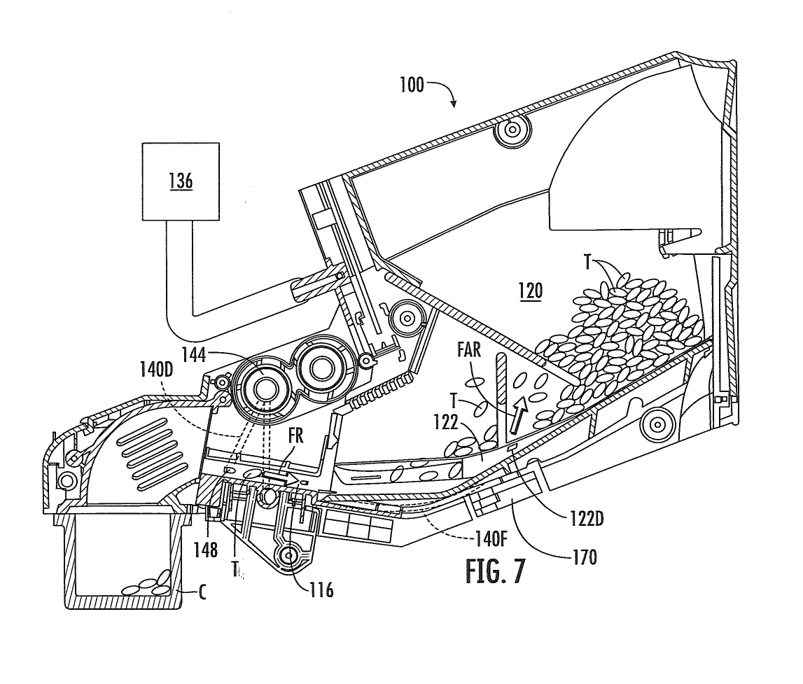

With reference to FIGS. 5 and 7, a gas supply passage or conduit 140B (FIG. 5) fluidly connects the high pressure nozzle 134 to a reverse control valve 144. A reverse jet supply passage 140D (FIG. 7) fluidly connects the reverse control valve 144 to a reverse drive jet aperture or outlet 148. The reverse jet outlet 148 is positioned and configured to direct air or other supplied gas into the dispensing channel 116. A rear agitation supply passage 140F (FIG. 7) fluidly connects the reverse control valve 144 to a rear agitation jet device 170. The rear agitation jet device 170 is positioned and configured to direct air or other supplied gas into the hopper chamber 120 through the rear agitation outlet 122D. The reverse control valve 144 is operable to control airflow to the reverse jet outlet 148 and the rear agitation jet device 170.

The gas supply passages 140A-F may be of any suitable construction and configuration. According to some embodiments, some or all of the passages 140A-F are defined in whole or in part by channels formed in the housing 110. These channels may be machined or molded into the housing 110.

Each of the agitation jet devices 150, 170 is secured to the housing 110. The agitation jet devices 150, 170 may be of any suitable construction to effect the functionality described herein. According to some embodiments, the agitation jet devices 150, 170 are constructed as described below with regard to the agitation jet device 150. The agitation jet devices 150, 170 may be constructed in the same or similar manners and it will therefore be appreciated that this description can likewise apply to the agitation jet device 170 (and/or any additional agitation jet devices).

According to some embodiments of the present invention, the bin 100 further includes a sensor 500 that is operative to detect the presence and/or fill level of solid pharmaceutical articles (such as the pills or tablets T), for example, in the hopper chamber 120. In some embodiments, the sensor 500 may be implemented using a capacitive-type pill level sensor to determine the presence and/or level of pills in the bin 100; however, it will be understood that many different sensor types may be employed. As illustrated in the flowchart of FIG. 13, a sensor 500 positioned in the bin 100 generates a detection signal indicative of a capacitance, and the detection signal is received at a controller coupled to the sensor 500 at block 1305. The controller may be the main controller 12 or another local controller associated with the bin 100. Based on the capacitance indicated by the detection signal, the controller detects or determines the presence and/or fill level of the pills in the bin at block 1310.

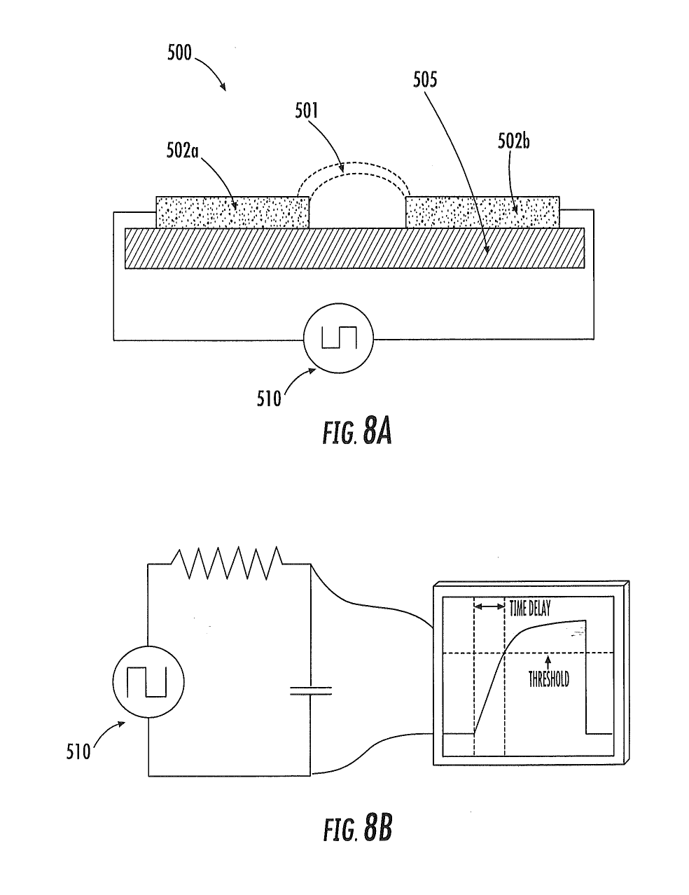

In particular, as shown in FIG. 8A, the capacitive-type pill level sensor 500 is used to measure the dielectric properties of a medium provided in the electromagnetic field 501 between two conductive electrodes 502a, 502b. The electrodes 502a, 502b are provided on a support material or substrate 505, and are driven by a frequency generator 510. The electrodes 502a, 502b and the medium therebetween define a capacitor, which along with the frequency generator 510 form a circuit, as shown in FIG. 8B. Changes or differences in dielectric constant (i.e., relative permittivity) or capacitance between the electrodes 502a, 502b are thus indicated based on changes or differences in the slope and threshold of the output signal of the circuit, which may be interpreted to determine the presence, absence, and/or fill level of pills or tablets T in the bin 100. For example, as discussed below, a controller coupled to the sensor 500 may interpret an increase in the measured dielectric constant as an indication of the presence and/or level of pills.

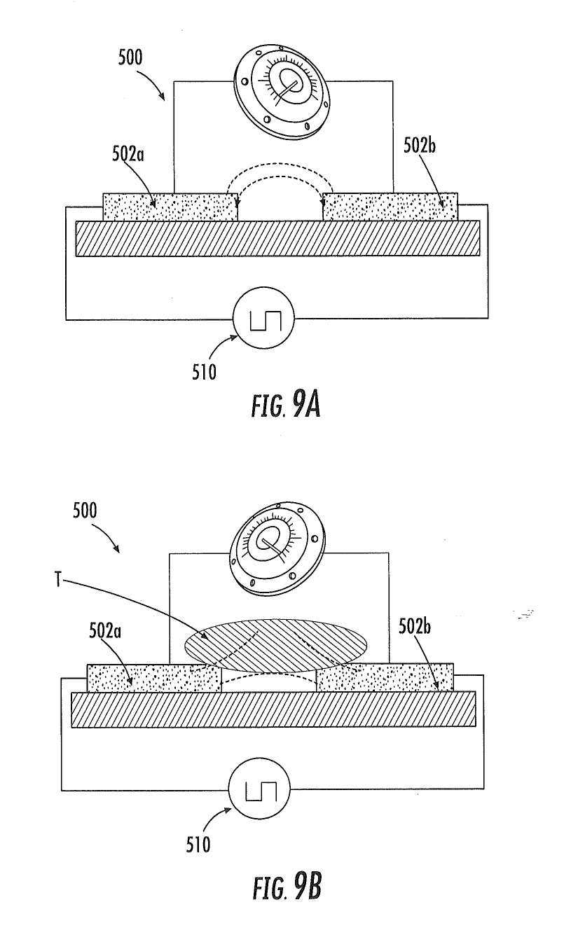

FIG. 9A illustrates operation of the circuit to measure the dielectric constant when the medium between the electrodes 502a, 502b is air, that is, when no pills are present between the electrodes 502a, 502b. In particular, as shown in FIG. 9A, when no pills are present between the electrodes 502a, 502b, the dielectric constant indicated by a detection signal generated by the sensor 500 is equal to the sum of average dielectric constant of the sensor substrate and air, which may approach 1 (e.g., the dielectric constant of air) as the dielectric constant of the sensor substrate is reduced or minimized. This measurement may be interpreted by a controller (such as the main controller 12 or another local controller associated with the bin 100) to indicate an absence of pills between the electrodes 502a, 502b of the sensor 500.

FIG. 9B illustrates operation of the circuit to measure the dielectric constant when a pill/tablet T or other solid article is present between the electrodes 502a, 502b. In particular, when one or more pills are present between the electrodes 502a, 502b, the dielectric constant indicated by the detection signal generated by the sensor 500 will increase (e.g., will be greater than 1/the dielectric constant of air). This measurement may thereby be interpreted by a controller (such as the main controller 12 or another local controller associated with the bin 100) to detect or indicate the presence of one or more pills between the electrodes 502a, 502b of the sensor 500. As such, the sensor 500 may be modeled as or electrically equivalent to a variable capacitor. The measured dielectric constant may also be interpreted to determine or indicate an amount or fill level of the pills in the bin 100, for example, based on a physical location and/or orientation of the sensor 500 in the bin.

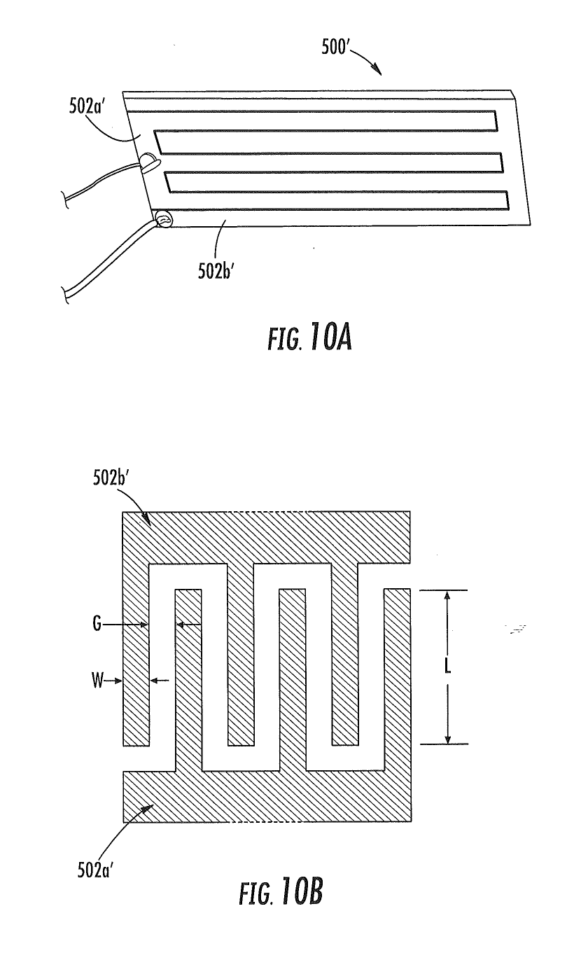

FIG. 10A illustrates an example pill level sensor in accordance with some embodiments of the present invention. In FIG. 10A, the pill level sensor is implemented as an interdigital capacitor 500′. As shown in FIG. 10A, an interdigital capacitor 500′ includes conductive electrodes 502a′, 502b′ shaped as interlocking “fingers” that provide coupling between input and output terminals across gaps therebetween. The gaps between fingers 502a′, 502b′ may be substantially uniform in width. Different lengths (L) and/or widths (W) for the fingers 502a′, 502b′ may be specified, as shown in FIG. 10B. Also, the width of the gap (G) between fingers 502a′, 502b′ may be selected based on dimensions and/or shape of the pills/tablets to be detected. Other interdigital capacitor designs may also be used, for example, designs A-H as shown in FIG. 10C, and the dimensions of the fingers 502a′, 502b′ may also be adjusted to reduce the required area of the sensor 500′. For example, FIG. 10D illustrates several example interdigital capacitor sensor designs having different finger widths (W) and finger-to-gap ratios. In some embodiments, smaller gaps between sensor “fingers” may result in larger differences in sensor readings (i.e. sensitivity), lower ratio's of finger-width to gap-width may result in larger differences in readings (down to 2:1), and a double-sided sensor may provide a greater than 50% sensor reading increase, as shown in the attached Appendix. Factors in sensor design may include cost, ease of implementation, increase in capacitance change per adjustment/change in pill level, reduction of measurement variance, and/or reduction of electrical noise.

The sensors may be single-sided or double-sided in some embodiments. Since the conductors 502a′, 502b′ are typically mounted on a support substrate, materials and/or characteristics of the support substrate (for example, the thickness and/or dielectric constant of the support substrate) can also affect sensor performance. In addition, the thickness and/or resistivity of the conductors 502a′, 502b′ may also impact the electrical characteristics. Also, detection may vary according to pill type or quality, as some pills may have better/different capacitance/dielectric characteristics than others. As such, implementation of the sensor 500′ in accordance with some embodiments may vary based on the choice of materials used for the electrodes 502a′, 502b′, the thickness of the electrodes 502a′, 502b′, the gap between the electrodes 502a′, 502b′, the types/dimensions of the pills/tablets, the shape and/or number of fingers 502a′, 502b′, the type of support material or substrate, and/or the dimensions of the dispensing bin in which the sensor 500′ is to be used.

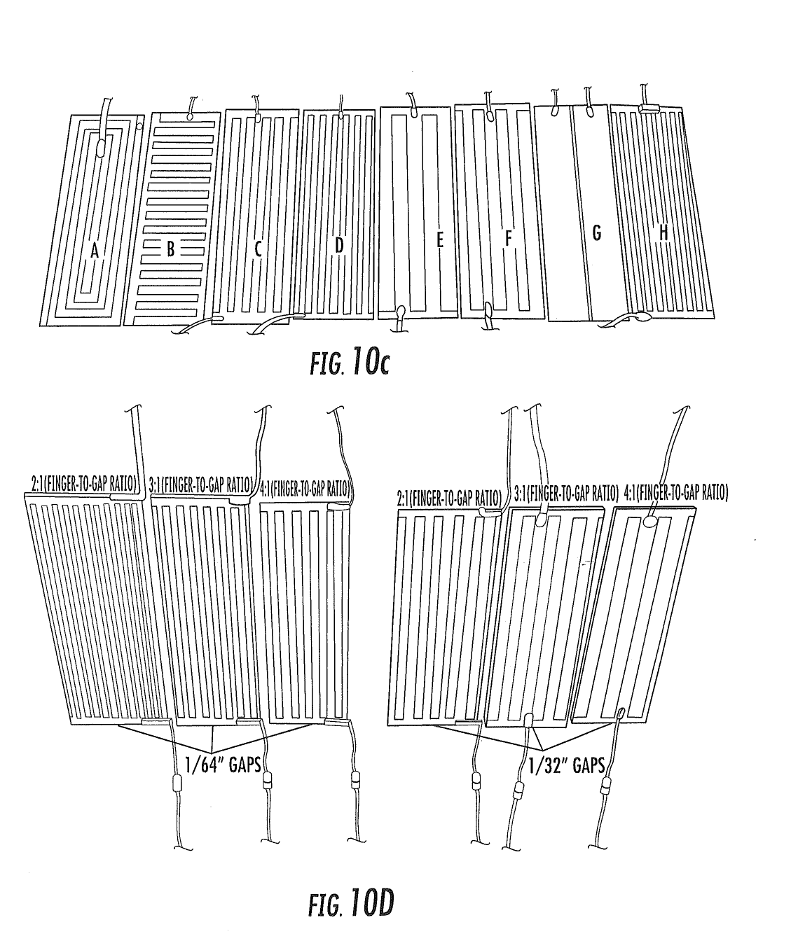

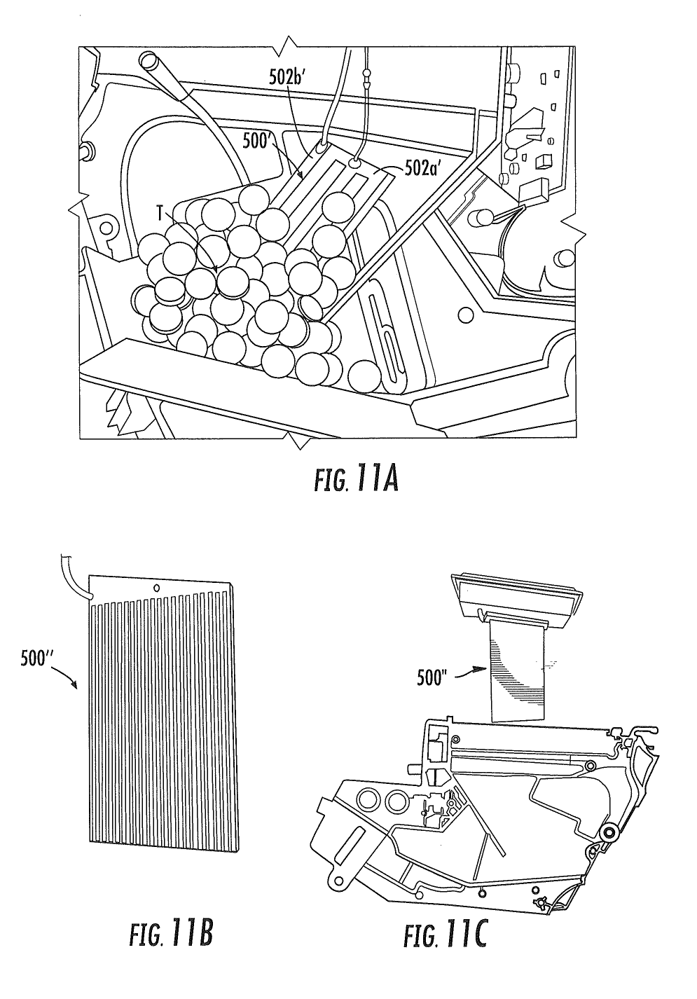

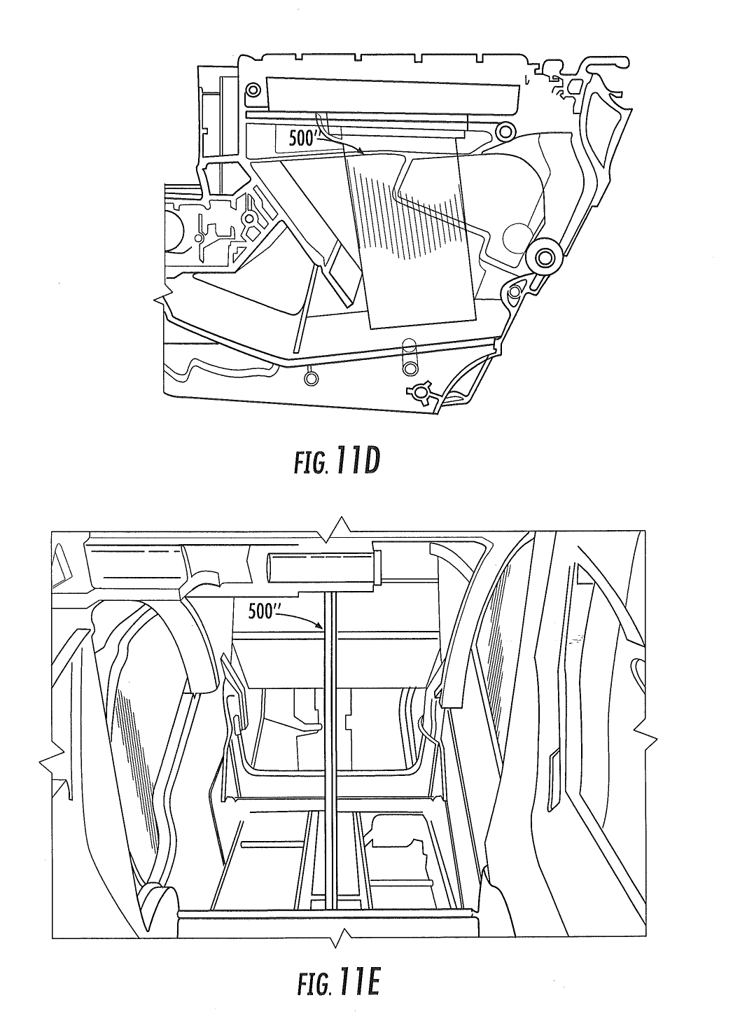

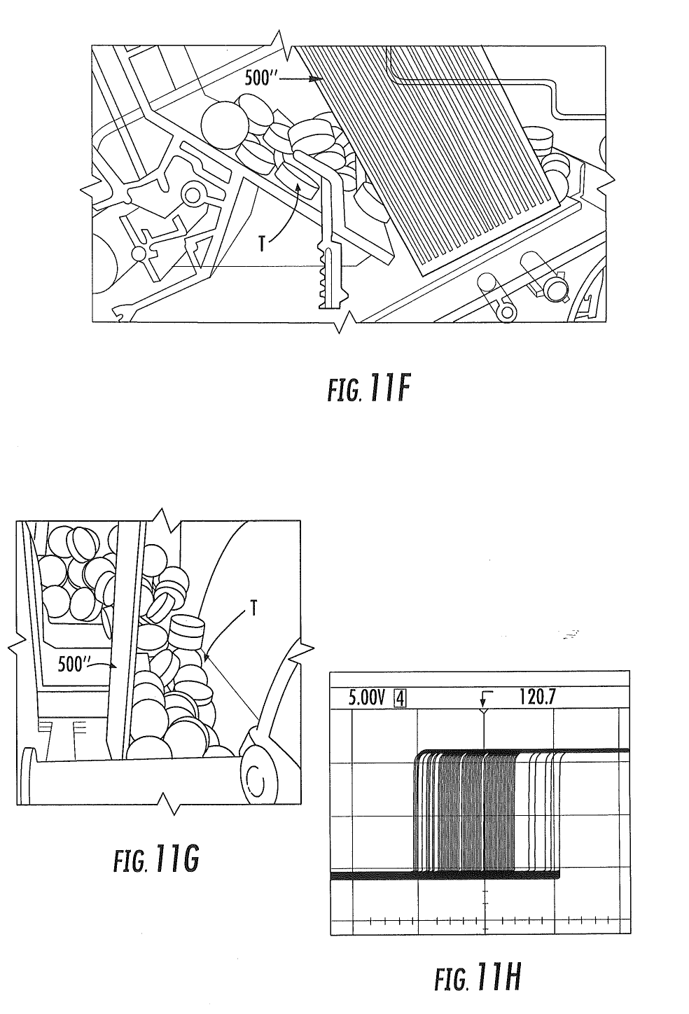

FIG. 11A illustrates the pill level sensor 500′ of FIG. 10A integrated in a dispensing bin, such as the bin 100 of FIGS. 3-7. As shown in FIG. 11A, the sensor 500′ is sized and configured for mounting on a sidewall of the hopper chamber 120 in the bin 100, such that the fingers 502a′, 502b′ extend along a height of the chamber 120. As such, when pills or tablets T contact the sidewall of the hopper chamber 120 including the sensor 500′ thereon, the dielectric constant between the fingers 502a′, 502b′ of the sensor may increase, thereby indicating the presence of the pills/tablets T. Alternatively, a sensor 500″ may be sized and configured for mounting in a location spaced apart from the sidewall of the hopper chamber 120, as shown by the physical orientations of the sensor 500″ in FIGS. 11B-11G. The measured dielectric constant may increase as the pills/tablets T accumulate in the hopper chamber 120, which may be interpreted as an indication as to the amount or fill level of the pills/tablets T in the chamber 120. The sensors 500′, 500″ may not be significantly affected by dust buildup or ambient light (in contrast to optical sensors), but sensor accuracy may depend on pills/tablets T being level within the cell. Also, electrical noise may affect the accuracy of readings, as shown in FIG. 11H, and there may be variance in measurements, for example, due to environmental factors (for instance, temperature and humidity). Such variance can be addressed, for example, by averaging readings over multiple cycles. It will be understood that the pill level sensors 500′, 500″ are not limited to use in the hopper chamber 120, but rather, may be sized and configured for use in other areas of the bin 100 (for example, in the dispensing channel 116), in other parts of the dispensing system 10 (for example, to monitor vial levels in the vial dispenser or cap levels in the cap dispenser), and/or for other uses (for example, for counting pills/tablets).

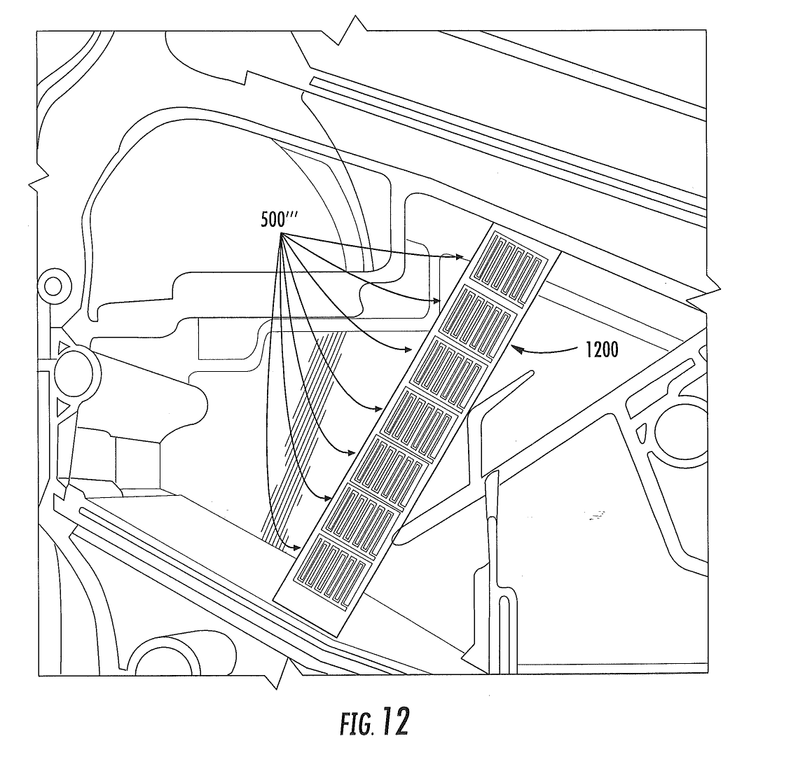

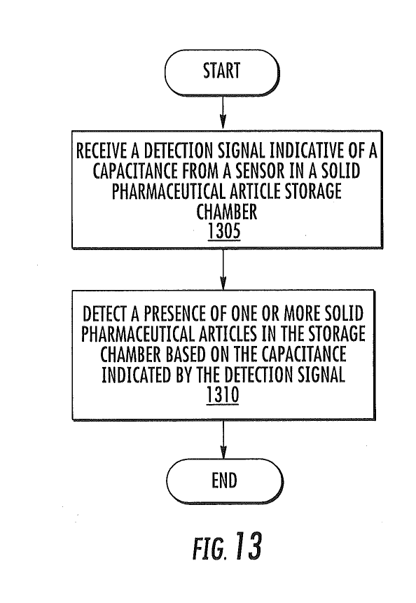

FIG. 12 illustrates a pill level sensor 1200 employing interdigital capacitors in a columnar arrangement or format according to further embodiments of the present invention integrated in a dispensing bin, such as the bin 100 of FIGS. 3-7. As shown in FIG. 12, the sensor 1200 is configured to measure the height or fill level of the pills in an automated pill dispensing cell using a column of variable capacitors, illustrated as seven interdigital capacitors 500′″ in a columnar arrangement along a height of the bin 100. Each capacitor 500′″ measures the dielectric constant between its electrodes, and may be coupled to an independent sensor circuit, such as the circuit shown in FIG. 8B, which may output a respective detection signal. The dielectric constant changes to the system are used to determine or sense pill height/fill level in the cell. In particular, the local presence of pills adjacent each capacitor 500′″ will raise the overall dielectric constant for that capacitor 500′″, as compared with proximity to air only. Based on the physical orientation of the sensor 1200 and the respective positions of the capacitors 500′″, the highest-positioned/uppermost one of the capacitors 500′″ in the column that registers an elevated dielectric constant can indicate the current height of pills in the cell, thereby providing a “gauge” as to the fill level. In other words, the fill level may be determined based on a comparison of respective dielectric constants indicated by respective detection signals generated by the capacitors 500′″ and the physical orientation of the sensor 1200 in the bin. In some embodiments, the respective detection signals generated by the capacitors 500′″ may indicate the respective positions of the capacitors 500′″ in the columnar arrangement, for example, based on addressing information included in the detection signal by the associated sensor circuits. It will be understood that implementation of the sensor 1200 may vary based on the choice of materials used for the electrodes, the thickness of the electrodes, the gap between the electrodes, the types/dimensions of the pills/tablets, the shape and/or number of fingers, and/or the type of support material or substrate. For example, the number of interdigital capacitors in each sensor 1200, the number/shape of fingers per capacitor, the electrode arrangement for each capacitor, and/or the finger width/gap width may be selected based on dimensions and/or shape of the pills/tablets to be detected, and/or based on the dimensions of the bin 100.

Embodiments of the present invention may thus utilize sensors as described above to alert an end-user or operator of a pharmaceutical dispensing system when the number of pills in a bin is running low or drops below a predetermined threshold. Embodiments of the present invention may also provide redundancy, which may provide high reliability pill measurement, increase accuracy with respect to the inventory of each bin and/or reduce the risk of losing inventory. As such, the downtime of the system may be reduced. The use of interdigital capacitor sensors may also provide a relatively inexpensive sensor solution compared with alternative sensors.

Embodiments of the present invention may be particularly advantageous in applications where large amounts of dust are present. For example, in a pharmaceutical dispensing environment, significant amounts of dust may be present due to the nature of the pills/tablets or other solid articles dispensed by the system. In particular, some pills/tablets may be prone to breakage, and small fragments thereof can accumulate as dust. As embodiments of the present invention may rely on physical contact between a pill and both electrodes of a sensor for detection, embodiments of the present invention may be largely unaffected by the presence of dust, as the sensor may be sized, configured, and/or otherwise positioned such that the accumulated dust may be insufficient to provide a “bridge” between the two electrodes of the sensor.

Although described herein primarily with reference to detection of pills in a dispensing bin, it will be understood that embodiments of the present invention are not limited to such a use, but rather, may be used in one or more other components/areas of the dispensing system 10. For example, sensors as described herein may be used to measure other solid pharmaceutical articles, such as (but not limited to) cap level, vial level, and/or label roll level. Sensors as described herein may also be shaped and/or otherwise configured to detect and/or count a number or quantity of pills, in addition to detecting the presence or level of pills.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present invention described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation, the scope of the present invention being set forth in following claims.

That which is claimed:

1. An apparatus for dispensing solid pharmaceutical articles, the apparatus comprising:
a dispensing bin having a solid pharmaceutical article storage chamber therein;
a sensor in the storage chamber, the sensor comprising first and second electrodes defining a plurality of interlocking fingers having respective gaps therebetween, wherein the sensor is configured to generate, a detection signal; and
a controller coupled to the sensor and configured to detect a presence of one or more solid pharmaceutical articles in the storage chamber based on the detection signal.

2. The apparatus of claim 1, wherein a capacitance indicated by the detection signal varies based on the presence of the one or more of the solid pharmaceutical articles between the fingers of the first and second electrodes.

3. The apparatus of claim 2, wherein the controller is further configured to determine a fill level of the solid, pharmaceutical articles in the storage chamber based on the capacitance indicated by the detection signal and a physical orientation of the sensor in the storage chamber.

4. The apparatus of claim 3, wherein the controller is configured to determine a dielectric constant between the fingers of the first and second electrodes based on the capacitance indicated by the detection signal, wherein the dielectric constant increases with quantity of the solid pharmaceutical articles based on the physical orientation of the sensor in the storage chamber.

5. The apparatus of claim 4, wherein, according to the physical orientation of the sensor, the interlocking fingers extend in a direction along a height of the storage chamber such that generation of the detection signal is substantially unaffected by dust in the storage chamber.

6. The apparatus of claim 4, wherein the sensor comprises a plurality of interdigital capacitors having respective pairs of the first and second electrodes and configured to generate respective detection signals, and wherein the controller is configured to determine the fill level based on a comparison of respective dielectric constants between the fingers of the respective pairs of the first and second electrodes indicated by the respective detection signals and the physical orientation of the sensor.

7. The apparatus of claim 6, wherein the physical orientation defines a columnar arrangement of the interdigital capacitors along a height of the storage chamber, and wherein the controller is configured to determine the fill level based on respective positions of the interdigital capacitors in the columnar arrangement.

8. The apparatus of claim 7, wherein the interdigital capacitors are coupled to respective independent sensor circuits configured to output the respective detection signals, and wherein the respective dielectric constants are indicated by relative operating frequencies of the respective sensor circuits.

9. The apparatus of claim 8, wherein the respective detection signals include information indicating the respective positions of the interdigital capacitors in the columnar arrangement.

10. The apparatus of claim 7, wherein the controller is further configured to determine that the fill level is below a predetermined threshold based on the respective detection signals and the respective positions of the interdigital capacitors in the columnar arrangement and generate an alert signal responsive thereto.

11. A method for dispensing solid pharmaceutical articles, the method comprising:
generating, by a sensor comprising first and second electrodes defining a plurality of interlocking fingers having respective gaps therebetween in a solid pharmaceutical article storage chamber, a detection signal; and
detecting, by a controller coupled to the sensor, a presence of one or more solid pharmaceutical articles in the storage chamber based on the detection signal.

12. The method of claim 11, wherein a capacitance indicated by the detection signal varies based on the presence of the one or more of the solid pharmaceutical articles between the fingers of the first and second electrodes.

13. The method of claim 12, further comprising:
determining a fill level of the solid pharmaceutical articles in the storage chamber based on the capacitance indicated by the detection signal and a physical orientation of the sensor in the storage chamber.

14. The method of claim 13, wherein determining the fill level of the one or more solid pharmaceutical articles comprises:
determining a dielectric constant between the fingers of the first and second electrodes based on the capacitance indicated by the detection signal,
wherein the dielectric constant increases with quantity of the solid pharmaceutical articles based on the physical orientation of the sensor in the storage chamber.

15. The method of claim 14, wherein the physical orientation of the sensor provides the interlocking fingers extending in a direction along a height of the storage chamber such that the generating the detection signal is substantially unaffected by dust in the storage chamber.

16. The method of claim 14, wherein the sensor comprises a plurality of interdigital capacitors having respective pairs of the first and second electrodes, and wherein the generating and the detecting comprise:
generating, by the interdigital capacitors, respective detection signals; and
determining, by the controller, the fill level based on a comparison of respective dielectric constants between the fingers of the respective pairs of the first and second electrodes indicated by the respective detection signals and the physical orientation of the sensor.

17. The method of claim 16, wherein the physical orientation defines a columnar arrangement of the interdigital capacitors along a height of the storage chamber, and wherein the determining the fill level further comprises:
determining the fill level based on respective positions of the interdigital capacitors in the columnar arrangement.

18. The method of claim 17, wherein the interdigital capacitors are coupled to respective independent sensor circuits that output the respective detection signals, and wherein the respective dielectric constants are indicated by relative operating frequencies of the respective sensor circuits.

19. The method of claim 18, wherein the respective detection signals include information indicating the respective positions of the interdigital capacitors in the columnar arrangement.

20. The method of claim 17, further comprising:
determining, by the controller, that the fill level is below a predetermined threshold based on the respective detection signals and the respective positions of the interdigital capacitors in the columnar arrangement; and
generating, by the controller, an alert signal responsive the determining that the fill level is below the predetermined threshold.

21. A computer program product, comprising:
a computer readable storage medium having computer readable program code embodied in the storage medium, wherein the computer readable program code, when executed by a processor, causes the processor to:
receive a detection signal from a sensor comprising first and second electrodes defining a plurality of interlocking fingers having respective gaps therebetween in a solid pharmaceutical article storage chamber; and
detect a presence and/or fill level of solid pharmaceutical articles in the storage chamber based on the detection signal.
